(19) United States
(12) Patent Application Publication
(10) Pub. No.: US 2026/0210827 A1
(43) Pub. Date: Jul. 23, 2026

(54) METHOD FOR DETERMINING AND/OR MONITORING THE VISCOSITY OF A MEDIUM, AND VIBRATION SENSOR

(71) Applicant: Endress+Hauser SE+Co. KG, Maulburg (DE)

(72) Inventors: Tobias Brengartner, Emmendingen (DE); Berthold Fuchs, Steinen (DE); Laura Mignanelli, Maulburg (DE); Harald Bauer, Lörrach (DE)

(21) Appl. No.: 19/140,632

(22) PCT Filed: Dec. 15, 2023
(86) PCT No.: PCT/EP2023/086123

§ 371 Date: Jun. 18, 2025

(30) Foreign Application Priority Data
Dec. 20, 2022 (DE) 10 2022 134 042.2

(51) Int. Cl. G01N 11/16

(52) U.S. Cl. CPC G01N 11/16

(57) ABSTRACT

A method for determining and/or monitoring the viscosity of a medium with a vibration sensor in which the oscillations of a unit, which can be mechanically oscillated, of the vibration sensor are used to determine whether the medium covers the unit which can be mechanically oscillated. If it does, subsequent oscillations are used to determine whether the medium continues to cover the unit. If it does not, a development over time of the oscillation quality is used to ascertain a statement about the viscosity of the medium. The invention also relates to a vibration sensor.

The invention relates to a method for determining and/or monitoring the viscosity of a medium. The invention also relates to a vibration sensor.

Mechanically oscillating units—e.g., tuning forks—of vibration sensors (see, for example, DE 10 2012 101 667 A1 ) are used to determine the limit level of a medium in a tank, inter alia. Typically, a measured oscillation frequency is used to determine whether or not the oscillating unit is touched by a medium.

For example, it is also possible to monitor the condition of the mechanically oscillating unit itself. In DE 10 2011 075 113 A1 , a damping ratio is determined from the difference between excitation frequencies in order to be able to detect build-up or corrosion during oscillations in the uncovered condition.

In addition to the fill level, there are other process quantities or properties of a medium that need to be monitored during a process. This is, for example, the viscosity of the medium, which is usually measured using very complex measuring equipment.

The object of the invention is to propose a method and a vibration sensor that carries out the method for determining or monitoring the viscosity of a medium.

The object is achieved by a method for determining and/or monitoring the viscosity of a medium with a vibration sensor, wherein the method comprises at least the following steps: exciting a mechanically oscillating unit of the vibration sensor to mechanically oscillate, receiving the mechanical oscillations of the mechanically oscillating unit, using at least one measured value for an oscillation quantity of the mechanical oscillations received to determine whether the medium covers the mechanically oscillating unit, in the event that the medium covers the mechanically oscillating unit, using at least one measured value for an oscillation quantity of the subsequently received mechanical oscillations to determine whether the medium continues to cover the mechanically oscillating unit, in the event that the mechanically oscillating unit is not covered by the medium, determining measured oscillation quality values from at least one measured value for an oscillation quantity of the subsequently received mechanical oscillations, and ascertaining a statement about the viscosity of the medium from the development of the measured oscillation quality values over time.

In the method according to the invention, the mechanical oscillations of the mechanically oscillating unit of the vibration sensor are evaluated. For example, the mechanical oscillations are converted into electrical signals. This is done, for example, using piezo elements as part of a transducer device. Measured values are then determined for oscillation quantities from the signals. The oscillation quantities are, for example, the amplitude, frequency or phase of the oscillations. In addition or alternatively, they can also be resulting quantities such as the oscillation quality. The measured values for the oscillation quantities are then in turn used to determine the measured values for the process quantities of interest, such as coverage by the medium or viscosity. In order to process the measured values for the oscillation quantities, stored formulas and/or data records such as reference values are used, for example.

The method for determining and/or monitoring viscosity takes place in a plurality of successive steps or stages. It is assumed that the mechanically oscillating unit is initially not covered by the medium as it oscillates, e.g., it oscillates in the air. If the fill level of the medium changes and the medium covers the—previously freely oscillating—mechanically oscillating unit, this can be recognized by the characteristics of the oscillations. For this purpose, at least one measured value for an oscillation quantity is in particular evaluated. The oscillations that occur after the unit has been covered are used to determine, in a second stage, whether said unit continues to be covered or whether the medium is no longer covering the mechanically oscillating unit, i.e., whether the oscillating unit oscillates freely and uncovered again. If this is the case, a measured oscillation quality value is determined as an oscillation quantity from the oscillations that follow in the third stage. The oscillation quality then makes it possible to detect a change in viscosity and/or to determine the value for the viscosity of the medium. This takes advantage of the fact that after the oscillating unit has been covered by the medium and subsequently uncovered, medium continues to adhere to the oscillating unit and only detaches after a certain amount of time. For the oscillating unit, the transition to being able to oscillate completely freely is therefore delayed. Therefore, the detachment behavior can be used to draw conclusions about the viscosity on the basis of the oscillation quality.

The sequence of the three stages shall be described once again in another way:
Stage 1: The oscillating unit oscillates in the uncovered state.
Stage 2: If the oscillating unit is covered by the medium, this can be determined from the at least one oscillation quantity. A switch from “uncovered” to “covered” is therefore detected.
Stage 3: When the medium is no longer covering said unit, this is also detected using the oscillation quantity. The statement about the viscosity is ascertained from the subsequent behavior of the oscillation quantity from the “end of coverage” to when the mechanical oscillating unit oscillates freely again. The way in which the unit returns to the normal state where it oscillates freely in the air is therefore evaluated.

It is therefore necessary for the medium to cover the oscillating unit and then once again to cease to cover it. If some of the medium remains on the mechanically oscillating unit, said unit is not covered by the medium per se. Coverage by the medium means in particular that the medium has such a fill level that the mechanically oscillating unit is below this fill level due to its dimensions and arrangement. If the unit is no longer covered, the fill level of the medium drops below the position of the oscillating unit. The way in which the medium drips off the mechanically oscillating unit is then monitored.

One embodiment of the method includes the fact that, in the event that the mechanically oscillating unit is not covered by the medium, measured oscillation quality values are only determined from the at least one measured value for the oscillation quantity of the subsequently received mechanical oscillations if the mechanically oscillating unit was covered by the medium at least for a predetermined coverage time and/or at least during a predetermined number of mechanical oscillations. In this embodiment, care is taken to ensure that the mechanically oscillating unit has been in the medium for a sufficient amount of time and has performed mechanical oscillations. This is ensured by specifying a period of time or a number of oscillations to be completed. The oscillations precondition the medium to a certain extent by the vibration of the oscillating unit causing the medium, which is preferably a liquid, to experience shear stress. In this embodiment, the medium is thus moved in the second stage and thus conditioned in order to be able to perform reproducible measurements.

One embodiment of the method provides that the oscillation quantity from which it is determined whether the medium is covering the mechanically oscillating unit is a frequency of the oscillations received. In this embodiment, the frequency of the oscillations received is used to infer whether the medium is covering the oscillating unit.

In an alternative or additional embodiment, the frequency is used to determine whether the medium continues to cover the oscillating unit.

One embodiment of the method involves ascertaining a statement about the viscosity of the medium on the basis of the development of the measured oscillation quality values over time up to a starting value. This embodiment evaluates the oscillation quality behavior in relation to a starting value once the unit is no longer covered and once the unit is covered. For example, an evaluation is performed as to how the quality re-adapts to the starting value.

The aforementioned starting value is specified in one embodiment. In an alternative embodiment, the measured value for the starting value of the oscillation quality is determined from the oscillations in the uncovered state. This starting value is therefore also suitable for each of the measuring conditions.

According to an additional embodiment of the method, at least one measured value for another oscillation quantity is used to ascertain the statement about the viscosity of the medium. The other oscillation quantity is preferably the frequency of the mechanical oscillations. In this variant, the time curve of the frequency is thus evaluated in comparison to when the oscillating unit is free and uncovered. For example, the speed at which the initial oscillation frequency value is reached is determined. Alternatively or additionally, the gradient with which the frequency approaches the starting value of the uncovered free oscillations is determined. For example, it has been shown that a transition of the frequency response from the covered to the free state allows conclusions to be drawn about the viscosity. A sharp-edged transition indicates a lower viscosity and a rounded transition indicates a higher viscosity.

One embodiment of the method provides that the statement ascertained refers to the value of the viscosity of the medium. Alternatively or additionally, the ascertained statement refers to the value range in which the viscosity of the medium lies. Likewise, the statement ascertained alternatively or additionally refers to whether the viscosity of the medium has changed beyond a specifiable tolerance range.

In one embodiment, a change in viscosity is thus detected, and therefore the vibration sensor acts as a kind of viscosity switch: a change in viscosity is displayed. Alternatively, a value or at least a range of values is determined for the viscosity of the medium. Values or value ranges are therefore determined and output.

One embodiment of the method includes the fact that, in the case that the mechanically oscillating unit is not covered by the medium, the mechanical oscillations received belong to the decay behavior of the oscillations of the mechanically oscillating unit. In this embodiment, once the mechanically oscillating unit is no longer covered by the medium, it is no longer excited to oscillate, but instead oscillations are only received and evaluated.

The object is additionally achieved by a vibration sensor comprising a mechanically oscillating unit (e.g., a tuning fork, a single rod or a membrane) and a control device for operating the mechanically oscillating unit and for recording oscillations of the oscillating unit, wherein the control device (e.g., at least comprising a transducer device, which preferably comprises at least one piezo element, and an electronic device for processing electrical signals and for executing measurement procedures) is designed to carry out the method according to any one of the preceding or following embodiments. The vibration sensor is therefore capable of implementing the method. Alternatively, the vibration sensor only performs the measurements and the evaluation process takes place in a unit that is, for example, separate from the process.

The invention will be described in the following with reference to embodiments.

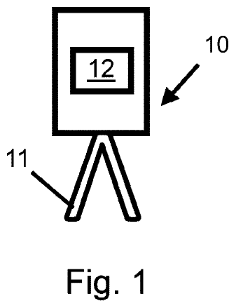

FIG. 1 shows an example vibration sensor,

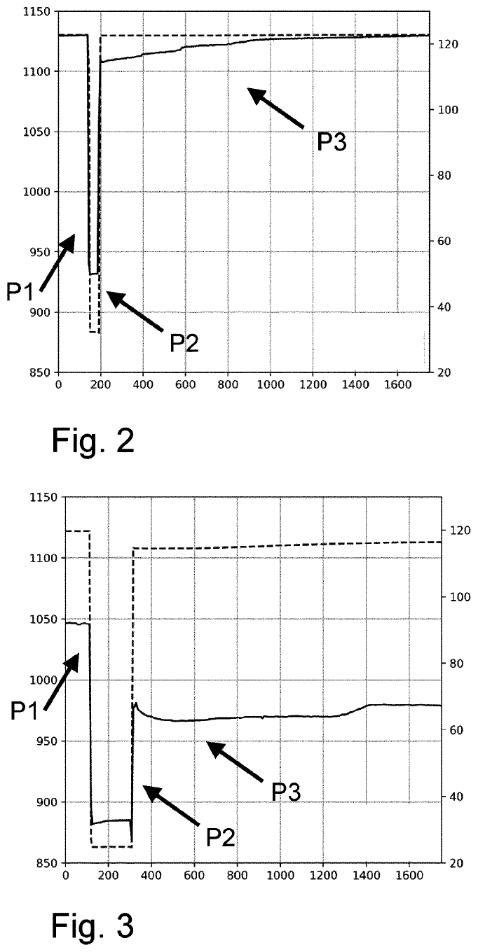

FIG. 2 shows the curve of the frequency of the oscillations and the quality of the oscillating circuit in an uncoated oscillating unit when covered with water,

FIG. 3 shows the frequency and quality curves in a coated oscillating unit when covered with water,

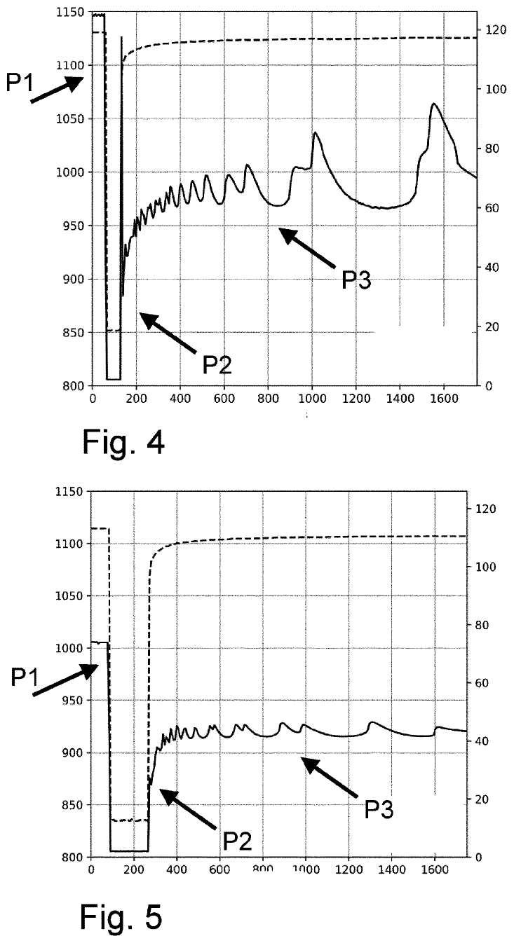

FIG. 4 shows the frequency and quality curves in an uncoated oscillating unit when covered with a highly viscous liquid, and,

FIG. 5 shows the frequency and quality curves in a coated oscillating unit when covered with a highly viscous liquid.

FIG. 1 shows an example vibration sensor 10, which has a mechanically oscillating unit 11, which is designed here as a tuning fork, and a control device 12. A medium—not shown here—influences the oscillation properties of the oscillating unit 11 as soon as it touches the oscillating unit 11. The mechanically oscillating unit 11 is excited to oscillate by the control device 12. In this case, the control device 12 thus comprises a transducer device such as a piezo element, and electronics which executes a measuring program and also evaluates the oscillations received or the resulting electrical signals.

Due to repeated wetting and drying as a result of fill level fluctuations that occur, a coating of media residues can form on the oscillating unit 11 over time. This coating manifests itself, among other things, in a shift in the oscillation frequencies toward lower ranges. However, this influence is usually slow to appear, i.e., in cases of more pronounced coatings. This is indicative of the robustness of the measuring method.

FIG. 2 to 5 show how the method allows the viscosity of a preferably liquid or flowable medium to be monitored or determined. They each show example time curves for the oscillation frequency (dashed line in each case) and quality (solid line in each case) for a mechanically oscillating unit 11 in different conditions (with or without a coating thereon) influenced by different media (water or highly viscous medium). The x-axis is the time in seconds. The left y-axis is the frequency in Hertz and the right y-axis is the unitless quality.

FIG. 2 shows the time curve of the oscillation frequency and oscillation quality of an uncoated mechanically oscillating unit 11.

The oscillating unit 11 oscillates in a dry first stage P1, e.g., in the air, is immersed in water as the medium in an immersion stage P2 and then dries in the third stage P3. With the separation of the water from the oscillating unit 11, i.e., during the transition from the covered to the uncovered state, the frequency almost immediately assumes the oscillation frequency of the dry state in P1 of slightly above 1100 Hz, whereas the quality requires approximately 1000 seconds to reach an initial state with an oscillation quality of slightly above 120 as the starting value. The quality shows a sensitivity to the presence of a water film which flows away in drops (gradations over time).

FIG. 3 shows the curves for the oscillation frequency and oscillation quality when immersed in water and when a coating, for example made of cement, is present on the mechanically oscillating unit 11.

After immersion in the medium (immersion can consist of changing the position of the oscillating unit or changing the fill level of the medium), the frequency very quickly reaches values above 1100 Hz in stage P2, whereas the quality remains at a value around 70. It has been found that the quality is a good measure for detecting a coating.

In both cases (FIG. 2 and FIG. 3), a similar quality curve is shown: there is initially a strong increase, followed by a portion with a relatively constant value.

FIG. 4 shows time curves for the oscillation frequency and quality of an uncoated mechanically oscillating unit 11 when immersed in a viscous medium with a viscosity of approximately 1000 square millimeters per second.

As in the case in FIG. 2 with water as the medium, a rapid return of the oscillation frequency to values in the range in the unwetted state is observed. However, it should be noted that the transition is rounded and not as sharp-edged as when the medium is water. Moreover, the oscillation frequency approaches the starting value more slowly than in the case in FIG. 2.

However, the oscillation quality shows a fluctuation between values in the range between 50 and 80 after separating the medium 21 from the oscillating unit 11. This fluctuation is caused by the medium 21 dripping and running off the oscillating unit 11. At the same time, it can be seen that the quality allows conclusions to be drawn about the viscosity of the medium. In the case of water, FIG. 2 shows an almost adiabatic increase in quality that approaches a starting value. In contrast, FIG. 4 shows oscillating behavior with valleys between the individual deflections that become longer over time. Therefore, a statement about the viscosity of the medium can be derived from the quality or behavior over time.

FIG. 5 shows oscillation frequency and oscillation quality curves when immersed in the medium 21 and when the mechanically oscillating unit 11 comprises a coating-again a cement coating as an example.

In contrast to the graph in FIG. 4, the oscillation quality remains in the region of 40 for a long period of time, i.e., significantly below the oscillation quality when there is no cement coating. Nevertheless, clear and different behavior is observed in comparison with FIG. 3, which allows conclusions to be drawn about the viscosity.

In general, it should be noted that the shape and course of the curves may depend on properties of the mechanically oscillating unit. This refers, for example, to the geometry, the type of coating that may be present or the material of the mechanically oscillating unit. They may also be dependent on the type and design of the transducer unit and/or the type of oscillation excitation.

1-8. (canceled)

9. A method for determining and/or monitoring the viscosity of a medium with a vibration sensor, the method comprising:
exciting a mechanically oscillating unit of the vibration sensor to mechanically oscillate;
receiving the mechanical oscillations of the mechanically oscillating unit;
determining whether the medium covers the mechanically oscillating unit by using at least one measured value for an oscillation quantity of the mechanical oscillations received;
when the medium covers the mechanically oscillating unit, determining whether the medium continues to cover the mechanically oscillating unit by using the at least one measured value for the oscillation quantity of subsequently received mechanical oscillations;
when the mechanically oscillating unit is not covered by the medium, determining measured oscillation quality values from the at least one measured value for the oscillation quantity of subsequently received mechanical oscillations, and
making a statement about a viscosity of the medium from a development of the measured oscillation quality values over time.

10. The method according to claim 9,
wherein, when the mechanically oscillating unit is not covered by the medium, the measured oscillation quality values are only determined from the at least one measured value for the oscillation quantity of the subsequently received mechanical oscillations if the mechanically oscillating unit was covered by the medium at least for a predetermined coverage time and/or at least during a predetermined number of mechanical oscillations.

11. The method according to claim 10,
wherein the oscillation quantity from which it is determined whether the medium is covering the mechanically oscillating unit is a frequency and/or an amplitude of the received mechanical oscillations.

12. The method according to claim 9,
wherein the statement about the viscosity of the medium is made based on a development of the measured oscillation quality values over time up to a starting value.

13. The method according to claim 12,
wherein at least one measured value for another oscillation quantity is used to ascertain the statement about the viscosity of the medium.

14. The method according to claim 9,
wherein the statement about the viscosity of the medium refers to a value of the viscosity of the medium or a value range in which the viscosity of the medium lies or whether the viscosity of the medium has changed beyond a specifiable tolerance range.

15. The method according to claim 9,
wherein, if the mechanically oscillating unit is not covered by the medium, the mechanical oscillations received belong to a decay behavior of the oscillations of the mechanically oscillating unit.

16. A vibration sensor, comprising:
a mechanically oscillating unit; and
a control device for operating the mechanically oscillating unit and for recording oscillations of the mechanically oscillating unit;
wherein the control device is designed to:
excite the mechanically oscillating unit to mechanically oscillate;
receive the mechanical oscillations of the mechanically oscillating unit;
determine whether a medium covers the mechanically oscillating unit by using at least one measured value for an oscillation quantity of the mechanical oscillations received;
when the medium covers the mechanically oscillating unit, determine whether the medium continues to cover the mechanically oscillating unit by using the at least one measured value for the oscillation quantity of subsequently received mechanical oscillations;
when the mechanically oscillating unit is not covered by the medium, determine measured oscillation quality values from the at least one measured value for the oscillation quantity of subsequently received mechanical oscillations, and
make a statement about a viscosity of the medium from a development of the measured oscillation quality values over time.
